(19) United States
(12) Patent Application Publication
(10) Pub. No.: US 2003/0162502 A1
(43) Pub. Date: Aug. 28, 2003

(54) Radio frequency (rf) Transceiver

(76) Inventor: Adam Loveridge, Northants (GB)

Correspondence Address: Martin Fleit, Fleit Kain Gibbons Gutman & Bongini, 601 Brickell Key Drive, Suite 404, Miami, FL, 33131, US

(21) Appl. No.: 10/311,675

(22) PCT Filed: Jun. 20, 2001
(86) PCT No.: PCT/GB01/02751

(30) Foreign Application Priority Data
Jun. 20, 2000 (GB) 0015223.1

(51) Int. Cl. H04B 1/10

(52) U.S. Cl. 455/63; 455/67.3

(57) ABSTRACT

A half-duplex radio frequency (RF) transceiver (10) includes a transmitter (12) and a receiver (14), the transmitter (12) receives a signal from a modulator (15) which modulates data onto a carrier signal An amplifier is provided for amplifying said modulated carrier signal so that it is capable of being transmitted. A divertor means (18) is provided for diverting a portion of said modulated carrier signal, prior to transmission, via the components of a receive channel in the receiver (14), to a processor (16), so that, in use, the diverted portion of carrier signal is compared with the transmitted signal and a correction signal is generated, the correction signal being used to correct distortion produced in the transmitted signal.

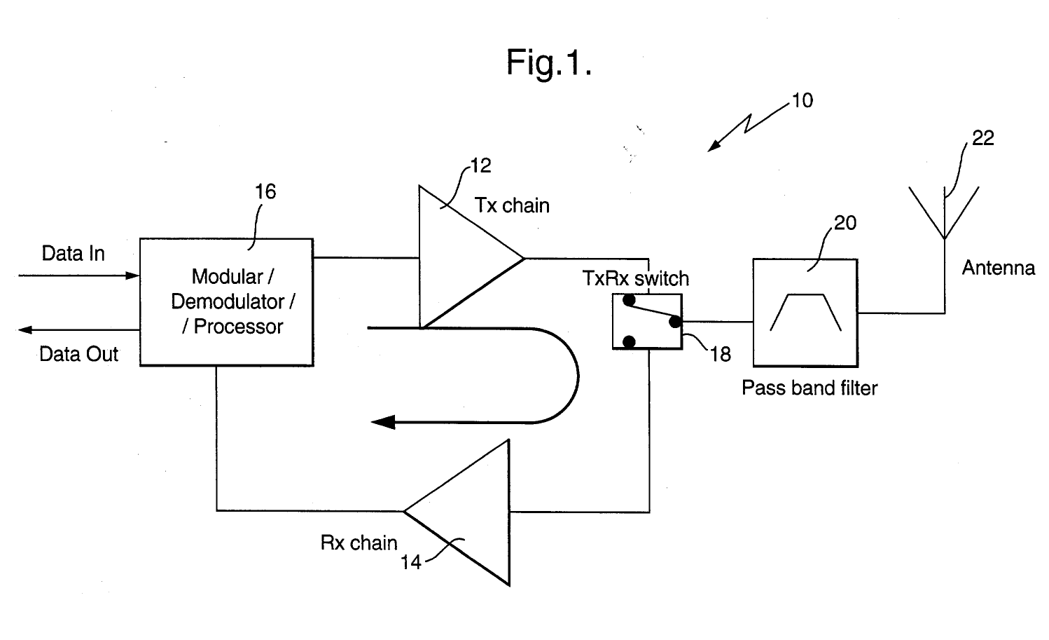

The present invention relates to a radio frequency (RF) transceiver. More particularly, but not exclusively, the invention relates to a radio frequency transceiver which carries data or voice transmissions as part of a radio frequency (RF) communication system.

A type of radio frequency communication system is that employed in cellular mobile telephone networks. Typically mobile telephone network communication systems comprise: a plurality of cells, in each of which there is located transmitter/receiver beacons which broadcast and receive RF signals. RF signals are sent from, and received by, mobile telephones (transceivers) which enter into cells, move through and ultimately leave cells.

In conventional RF mobile telephones, and indeed other forms of RF transmitters, the transmitter consumes a relatively high proportion of the power consumed. One way of reducing power consumption is to maintain the transmitter in a linear operating region.

A number of other techniques have been developed in order to reduce power consumption and therefore improve transmission efficiency. An example is the use of linearisation during final output stages of a transmitter output chain. However, these techniques require additional components and therefore add to cost and complexity of transmitters. Moreover, even when miniaturised, they add to bulk and weight of mobile telephones.

Commonly, linear Power Amplifier systems that employ additional components for detecting and feeding back distortion information are to be found in expensive Frequency Division Duplex systems, where cost is no problem, and where the receiver is always in operation and cannot be used to detect and feed back distortion information. Examples of such systems that employ additional circuits are British Patent 2,254,973A (Motorola); European Patent Application 092 8088 A2 (Alcatel); U.S. Pat. No. 5,740,520 (Israel); U.S. Pat. No. 5,819,165 (Nokia) and U.S. Pat. No. 5,910,965 (Harris).

An example of combined linear power amplifier and related method is described in U.S. Patent U.S. Pat. No. 5,986,500 (SAMSUNG). The aforementioned Patent describes a device and method for combining outputs of several linear power amplifiers in the event that, for example, one or more fail.

Another example of how a linear power amplifier improves efficiency is described in U.S. Patent U.S. Pat. No. 6,043,712 (MOTOROLA). There is described a linear power amplifier for use in Cartesian feedback loops. The amplifier reduces current drain in low voltage linear amplifiers which, for example, are used in Time Division Multiplex Access (TDMA) systems.

None of the aforementioned linear Power Amplifier systems make use of the components of the on-board receiver circuits to detect and feed back distortion information from the transmitted signal.

The present invention arose in order to provide a transceiver having a radio transmitter, capable of operating with greater efficiency than has heretofore been achievable.

An important aspect of the present invention as claimed in the attached claims is that the transceiver utilises the components of the receiver circuit to detect and feed back distortion information.

The Power Amplifier linearisation system of the present invention may be applied to commercial Time Division Duplex systems where the transmitter and receiver operate in separate time slots (eg, the mobile telephone handset).

Although a number of publications discuss the theory of linearising conventional transmitters by linearising their transmission chains, there is no suggestion of using existing, on board receiver architecture, when in a non-active state, as a pathway or route for a feedback technique for linearisation.

Typically gains of greater than 70 dB are present on receive channels, therefore only extremely small signals are required to be removed in order to be used as part of the pre-distortion correction stage.

Previously loss of detectors has been seen as deleterious to efficient operation of the power amplification stage of transmitters as it introduced a loss; (albeit relatively small) whereas, by implementing the present invention, there is no additional loss incurred.

As a result of the distortion being cancelled, and a “cleaner” signal being provided to a transmit channel, less overall loss is suffered by the transmitter as it is operating more efficiently.

Preferably the means for diverting a portion of the carrier signal, prior to transmission, includes a transmit/receive switch which is operable either to switch a transmitter or transmit chain “in line” and simultaneously a receiver or receive channel “off line”, or vice versa. Alternatively a circulator may be used. It is important to note that only a very small feedback signal is required due to the very large gain which is inherent in a receive channel. Therefore in both cases the isolation loss feeds ample signal to the receive circuit.

Where the gain control of the receiver is not able to cope with the high level of signal fed back into the receive chain, additional attenuation can be provided, for example, via bias control (turning stages off), or by the addition of controllable attenuators in the receive chain.

Processing means may be used to adjust the modulated carrier signal prior to transmission. Preferably the processing means includes a digital processor which is switched into a control mode automatically when a data signal is provided to the modulator. Modulated data signal is then preferably transmitted via a low pass filter. The low pass filter is used to ensure the corrected signal is transmitted in accordance with relevant licence requirements for the approved operational bandwidth.

The aforementioned aspect of the invention has been described with reference to a transceiver when used in a half duplex mode; that is a transceiver capable of operating either in receive or transmit mode at any instant.

Correction of the signal preferably is in the form of a pre-distort signal. Advantageously the modulation is pre-distorted by an amount determined by a micro-processor.

Processing means is advantageously included. The processing means may take the form of a digital tuner. The processing means may be used to remove or reduce multipath effects by compensating for multipath dispersion.

Parameters which are corrected by the pre-distort signal include amplitude and phase.

A preferred embodiment of the invention, will now be described, by way of example only, and with reference to the accompanying drawing which is a simplified diagrammatical view of a half-duplex transceiver.

Referring to the drawing, there is shown generally a transceiver 10. Transceiver 10 comprises a transmitter 12 and receiver 14. Data is modulated onto a carrier signal by a modulator of the processor 16. The modulator may also be adapted to demodulate received signals as described below. Modulated data carrier is then amplified in the transmit chain 12 and routed to a transmit/receive switch 18, then via band pass filter 20, to antenna 22. An example of a transceiver is a mobile telephone.

During transmission of signal, a sampled portion of the signal is diverted or coupled to receiver 14 via transmit/receive switch 18. Typically the amount of coupled signal is of the order of 1×10⁻³ of the transmitted signal. However, as a result of gain in the receiver 14, this signal is amplified to a signal of an order of magnitude which is suitable for comparing with the original (non-distorted) or modulated carrier signal. Comparison of the sampled portion of the transmission signal and the original modulated signal is performed in order to provide a corrected signal or to generate a pre-distort signal. The comparison is made in the processor 16.

Digital processor 16 can be configured to perform other tasks automatically. For example, the processor can monitor received signal strength and modify output power and pre-distort characteristics according to received signal strength. Alternatively (or additionally) the digital processor may shift the phase of data and/or carrier signals so as to enhance the pre-distortion process and thereby avoid (or reduce) spectral regrowth.

In any modulation scheme it is possible to quantify distortion by observing amplitude limiting and phase shifting, as the modulation signal trajectory moves from state to state. (This is still possible in high bit/symbol schemes). The amount of distortion is quantified by comparing the trajectory against the known trajectory of the undistorted modulation signal as the signal enters each state. If the comparison results in acceptable criteria being attributed, then no further action is taken. However, if the quality of the received signal is so degraded, when compared with what is expected according to a predetermined set of criteria, then processor 16 corrects/pre-distorts subsequent modulation.

This modified carrier, when received by the receiver 14, does not suffer from the distortion that the previous (uncorrected) received signal exhibited. If it does then the pre-distort process is repeated.

An embodiment of the inventions has been described by way of an example only and it will be appreciated that variation to the embodiment may be made without departing from the scope of the invention.

1. A radio frequency (RF) transceiver, including a transmitter and a receiver, the transmitter receives a signal from a modulator that modulates data onto a carrier signal; an amplifier, for amplifying said modulated carrier signal so that it is capable of being transmitted; characterised in that a divertor means (18) is provided for diverting a portion of said modulated carrier signal, prior to transmission, via components of a receive channel in the receiver (14), to a processor (16), so that, in use, the diverted portion of carrier signal is compared with the transmitted signal and a correction signal is generated, the correction signal being used to correct distortion produced in the transmitted signal.

2. A transceiver according to claim 1 wherein the divertor means (18) for diverting a portion of the carrier signal, prior to transmission, includes a transmit/receive switch (18) which is operable either to switch a transmitter (12) or transmit chain “in line” and simultaneously a receiver or receive channel “off line”, or vice versa.

3. A transceiver according to claim 1 wherein the divertor means (18) for diverting a portion of the carrier signal, prior to transmission, includes a transmit/receive switch which in a first mode connects an antenna to a transmit circuit and in a second mode connects the antenna to the receiver circuit, the switch is constructed and arranged so that when the switch is in the first mode the receiver circuit receives sufficient signal as a result of the finite isolation that the switch has from transmit mode to receive mode. A transceiver according to any preceding claim wherein attenuation means is provided in the receiver (14).

4. A transceiver according to any preceding claim wherein processing means (16) is provided to adjust a modulator thereby to modulate the carrier signal prior to transmission.

5. A transceiver according to claim 4 wherein the processing means (16) includes a digital processor (16) which is switched into a control mode automatically when a data signal is provided to the modulator.
